(19) United States
(12) Patent Application Publication
(10) Pub. No.: US 2009/0154000 A1
(43) Pub. Date: Jun. 18, 2009

(54) METHOD AND APPARATUS FOR WRITING DATA WITH SEQUENTIAL ACCESS IN A DISK DRIVE

(75) Inventor: Shuuichi Kojima, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/245,494

(22) Filed: Oct. 3, 2008

(30) Foreign Application Priority Data
Dec. 13, 2007 (JP) 2007-322416

(51) Int. Cl. G11B 15/18

(52) U.S. Cl. 360/71; G9B/15.021

(57) ABSTRACT

According to one embodiment, a disk drive has a disk, a controller, and a flash memory, the request data to be recorded in the disk may be continuous data. In this case, the first one-track data item including the head address of the requested data is stored in the flash memory, and the second to last one-track data items are sequentially written in the disk.

### CROSS-REFERENCE TO RELATED APPLICATIONS

This application is based upon and claims the benefit of priority from Japanese Patent Application No. 2007-322416, filed Dec. 13, 2007, the entire contents of which are incorporated herein by reference.

### BACKGROUND

1. Field

One embodiment of the present invention relates to a disk drive. More particularly, the invention relates to a technique of writing data, which requires sequential access.

2. Description of the Related Art

In recent years, disk drives, a representative example of which is the hard disk drive, are used not only in file apparatuses for storing computer data, but also in video recording apparatuses for storing stream data (also called continuous data) such as digital video data.

The disk drive has at least one disk, which is a magnetic recording medium. On the disk, a number of concentric tracks (cylinders) are provided. Each track is divided into a plurality of data sectors. In the disk drive, read/write access is made to the disk in units of sectors, in order to read data from the disk or to write data in the disk.

In each disk drive recently developed, tracks are formed on the disk at high density in order to increase the recording capacity. The distance between any two adjacent tracks (i.e., tack pitch) has therefore become short. Consequently, when data is written in any track, part of the data is written over the data written in those parts of both adjacent tracks, which lie at the borders with the track.

If such over-writing of data is repeated, the data signal recorded on either adjacent track will become weak. In the worst case, the data becomes so weak that it can no longer be read. To solve this problem, a method is proposed in, for example, Jpn. Pat. Appln. KOKAI Publication No. 2004-273060. In this method, the number of times data has been written in each track is recorded, and data is read from and written again in the either adjacent track if the number of times reaches a prescribed value.

In the method disclosed in the above-identified prior-art reference, the number of times data is written in each track is limited, thereby to prevent the erasure of the data from the adjacent track.

The stream data such as digital video data is continuous data and may often surpass one-track storage capacity of the disk. To write or read the stream data, adjacent tracks of the disk must be sequentially accessed in many cases. In such sequential access, the number of times data-overwriting is performed on both tracks adjacent of each track may be limited to, for example, one. In this case, the track pitch can be reduced, ultimately increasing the storage capacity of the disk.

In the method disclosed in the above-identified prior-art reference, however, the number of times data is over-written on both tracks adjacent of each track cannot be limited to, for example, once only.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a disk drive according to an embodiment of the present invention;

FIG. 2 is a diagram explaining a substituted-track management table according to the embodiment;

FIG. 3 is a diagram explaining a different substituted-track management table according to the embodiment;

FIG. 4 is a diagram explaining how data items are recorded when a sequential access is performed in the embodiment;

FIG. 5 is another diagram explaining how data items are recorded when sequential access is performed in the embodiment;

FIG. 6 is still another diagram explaining how data items are recorded when sequential access is performed in the embodiment;

FIG. 7 is a diagram explaining the basic operation of the embodiment, illustrating the state in which data items are recorded in the disk;

FIG. 8 is a diagram explaining the basic operation of the embodiment, illustrating how data items are stored in a flash memory;

FIGS. 9A and 9B are diagrams explaining how data is written in the embodiment;

FIGS. 10A and 10B are other diagrams explaining how data is written in the embodiment;

FIGS. 11A and 11B are still other diagrams explaining how data is written in the embodiment;

FIGS. 12A and 12F are diagrams explaining the sequence of writing stream data in the embodiment;

FIG. 13 is a diagram showing a stream-data management table according to the embodiment;

FIGS. 14A and 14B are diagrams explaining how to manage the data stored in the flash memory provided in the embodiment;

FIG. 15 is another diagram explaining how to manage the data stored in the flash memory provided in the embodiment;

FIG. 16 is a flowchart explaining the process of writing stream data in the embodiment;

FIG. 17 is a flowchart explaining how to write stream data in the embodiment;

FIGS. 18A and 18B are diagram explaining how to write data in another embodiment of the present invention; and

FIG. 19 is a diagram explaining a substituted-track management table according to the other embodiment.

### DETAILED DESCRIPTION

Various embodiments according to the invention will be described hereinafter with reference to the accompanying drawings. In general, according to one embodiment of the invention, there is provided a disk drive in which the number of times data can be over-written on both tracks adjacent of each track is limited, thereby relatively reducing the track pitch and ultimately increasing the storage capacity of the disk.

(Configuration of the Disk Drive)

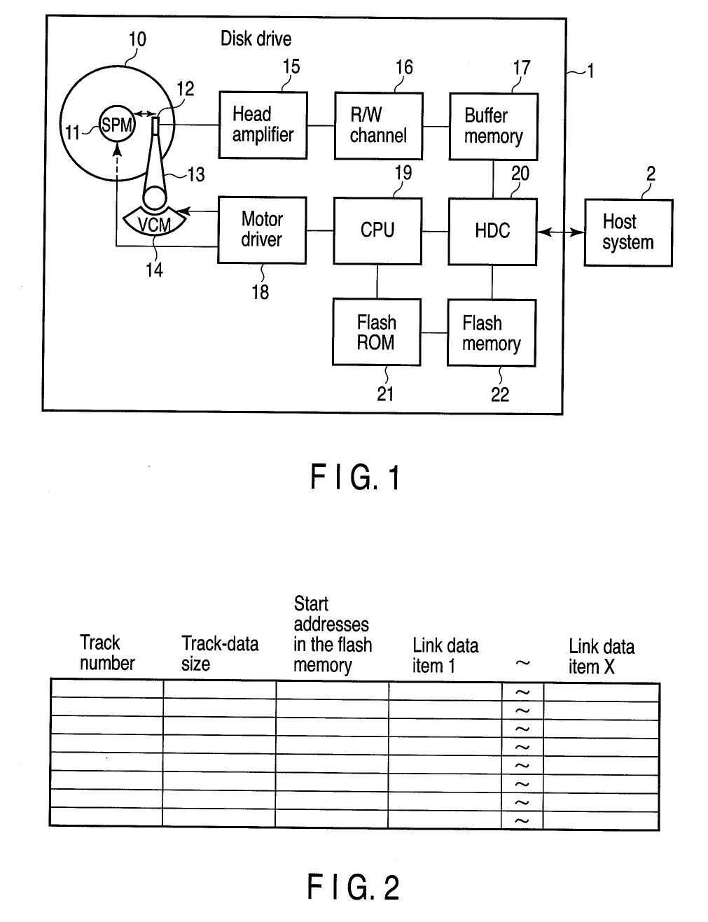

FIG. 1 is a block diagram showing the configuration of a disk drive according to an embodiment of this invention.

The disk drive 1 is a drive called hybrid-type disk drive that has a disk 10 and a flash memory 22, both used as media for recording user data. The disk 10 is a magnetic recording medium. The flash memory 22 is a nonvolatile semiconductor memory, more precisely a flash electrically erasable programmable ROM (EEPROM) in which data can be rewritten in units of blocks. The disk drive 1 has another flash memory (hereinafter called flash ROM, for convenience) 21 in addition to the flash memory 22 that stores user data. The flash ROM 21 stores various control data items when it is accessed by a microprocessor (CPU) 19.

The disk 10 has a number of concentric tracks. Each track is divided into a plurality of data sectors. Read/write access is made to the disk 10, in order to read data from the disk 10 or to write data from the disk 10, in units of sectors.

The disk drive 1 further has a spindle motor (SPM) 11, a head 12, an actuator 13, and a voice coil motor (VCM) 14. The spindle motor 11 rotates the disk 10. The head 12 has a write head for writing data in the disk 10 and a read head for reading data from the disk 10. The actuator 13 holds the head 12. When driven by the voice coil motor 14, the actuator 13 can move the head 12 over the disk 10 in the radial direction (arrows) of the disk 10.

Still further, the disk drive 1 has a head amplifier 15, a read/write (R/W) channel 16, a buffer memory 17, a motor driver 18, a CPU 19, and a disk controller (HDC) 20.

The head amplifier 15 includes a read amplifier and a write amplifier as in most cases. The read amplifier amplifies a read signal the read head has read from the disk 10. The write amplifier receives a write signal output from the read/write channel 16 and converts the same to a write current. The write current is supplied to the write head. The read/write channel 16 is a signal processing unit and has a read channel and a write channel. The read channel processes the read signal coming from the read head, decoding the same to original data. The write channel encodes the write data supplied from a host system 2.

The buffer memory 17 is a dynamic RAM (DRAM) as in most cases. When controlled by the disk controller 20, the buffer memory 17 stores read data or write data temporarily. The motor driver 18 includes a VCM driver and an SPM driver. The VCM driver controls the voice coil motor 14. The SPM driver controls the SPM 11.

The CPU 19 is the main controller in the disk drive 1 and controls mainly the read/write access to the disk 10. More precisely, the CPU 19 determines a target position over the disk 10, where the disk 10 should be accessed so that data may be read from, or written in, the disk 10, and controls the VCM driver of the motor driver 18, thereby driving the actuator 13 and ultimately performing a positioning operation, moving the head 12 to the target position. In most cases, the positioning operation includes a seek operation and a tracking operation. In the seek operation, the head 12 is moved, approaching target position. In the tracking operation, the head 12 is positioned at the target cylinder, i.e., target position.

The disk controller 20 is an interface that controls the transfer of read/write data between the disk drive 1 and the host system 2. The disk controller 20 performs a write operation in response to a write command coming from the host system 2, writing the write data transferred from the host system 2, in either the disk 10 or the flash memory 22. More specifically, in accordance with the write command, the disk controller 20 stores the write data temporarily in the buffer memory 17 and then transfers the write data from the buffer memory 17 to the read/write channel 16, so that the write data may be written in the disk 10. Further, the disk controller 20 performs a data-writing operation that accompanies the sequential access according to the present embodiment.

Moreover, the disk controller 20 performs a read operation in accordance with a read command coming from the host system 2, thus transferring the data stored in the buffer memory 17 or the data read from the flash memory 22 to the host system 2. The disk controller 20 performs a read-access to the disk 10 in accordance with the read command coming from the host system 2. More specifically, the disk controller 20 stores, in the buffer memory 17, the data read from the disk 10 and decoded by the read/write channel 16.

(Advantages of the Embodiment)

The principle of the data writing performed in the disk drive 1 according to this embodiment will be explained with reference to FIGS. 4 to 8.

FIG. 4 is a diagram explaining how the data recorded in each track become weak when data is written on the next track. Assume that data A has been written in a track N+1 provided on the disk 10. When data B is written in the next track N+2, part of data B is written over data A recorded in the track N+1, as is illustrated in FIG. 4. If such over-writing of data is repeated, the recorded signal representing data A will become weak. In the worst case, data A becomes so weak that it can no longer be read. In disk drives of ordinary type, tracks are provided on the disk at such a pitch that no recorded data is erased until the over-writing of data has been repeated more than, for example, 100,000 times.

FIG. 5 is a diagram explaining how data items N+1 to N+4 are written in tracks N+1 to N+4, respectively, when sequential access (hereinafter referred to as sequential write, in some cases) performed in the embodiment. As shown in FIG. 5, data items N+1 to N+3 have been over-written once, each in the adjacent track lying on one side when data items N+4 is written in track N+4. In the sequential write, each data item is over-written in the adjacent track on one side, only one time, as shown in FIG. 5. In other words, since each data item is over-written only once, the probability of data erasure in any track is extremely low even if the track pitch is short.

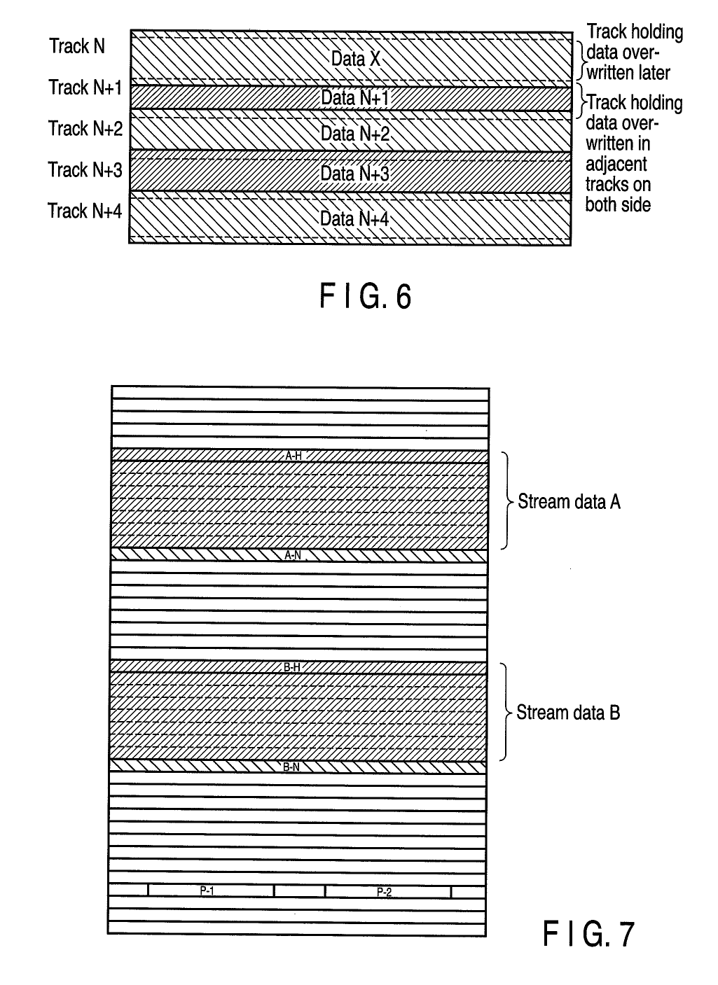

FIG. 6 is a diagram explaining how new data item X is written in track N after data items N+1 to N+4 have been sequentially written in tracks N+1 to N+4, respectively. In this case, data item N+1 written in track N+1 is over-written twice, first with data item N+2 recorded in track N+2 on one side of track N+1 and then with data item X recorded in track N. Therefore, the signal representing data item N+1 is more likely to be erased. Even in this case, the probability of data erasure in track N+1 is still low even if the track pitch is short, so long as data item N+1 is over-written only twice, first with data item N+2 and then with data item X.

In view of this, the present embodiment provides a data-writing method in which each data item is over-written in two tracks adjacent on both sides, only once, during the sequential write. The data-writing method according to this embodiment will be explained in detail, with reference to FIGS. 2, 3, 7 and 8, FIGS. 9A and 9B, FIGS. 10A and 10B, FIGS. 11A and 11B, FIGS. 12A and 12F, FIG. 13, FIGS. 14A and 14B, FIGS. 15, 16 and 17.

Assume that the present embodiment performs sequential write on the disk 10, to write continuous data, such as digital video data of a TV program, in more than one track, i.e., consecutive address areas of the disk 10. Hereinafter, the continuous data shall be called stream data. The stream data is stored as relatively large continuous data. The data managing the program attributes and the system data of the host system 2 are data items smaller than the stream data and may, therefore, be called non-stream data in some cases.

To perform the read/write access on the disk 10, the logic addresses (LBAs) supplied from the host system 2 are sequentially allocated to the sectors included in the consecutive tracks. That is, consecutive addresses are allocated to all tracks provided in the user area on one data-recording surface of the disk 10. Thus, the address allocation is based on the assumption that any logic address is never discontinuous to the next one. Nonetheless, the disk drive 1 may be so designed on the assumption that some logic addresses may be discontinuous to one another. In this case, the present embodiment can be applied, merely by providing a non-use area for one track at any position where a logic address is discontinuous to the next one.

(Basic Operation in the Data-Writing Method)

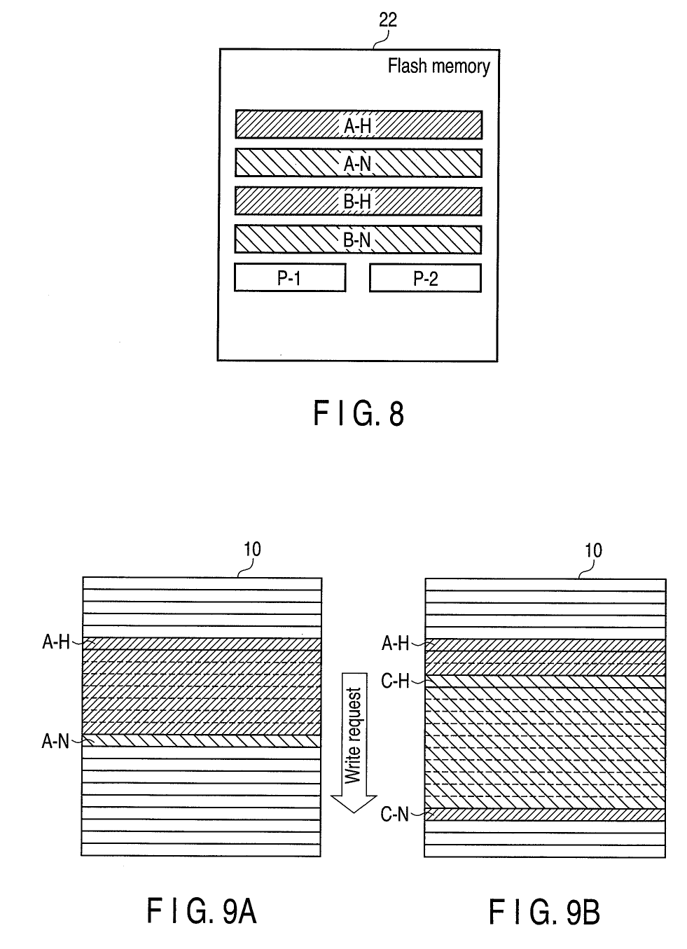

The basic operation in the data-writing method according to this embodiment will be explained with reference to FIGS. 7 and 8.

FIG. 7 is a diagram showing two stream data items A and B and two non-stream data items P-1 and P-2, all recorded in the disk 10 of the disk drive 1 according to the present embodiment. FIG. 8 is a diagram showing the data that is stored in the flash memory 22.

Stream data items A and B have been written in a plurality of tracks continuous to one another, by means of sequential write. Track data A-H is a one-track data item that contains the head address of stream data A. Track data item A-N is data other than stream data item A and is the data recorded in a track adjacent to the track having the end address for stream data item A. Like track data item A-H, track data item B-H is a one-track data item that contains the head address of stream data B. Like track data item A-N, track data item B-N is data other than stream data item B and is the data recorded in a track adjacent to the track having the end address for stream data item B.

As described above, stream data items A and B have been sequentially written. Therefore, they are over-written only once, each on one side of an adjacent track. Stream data items A and B may be written, each in the same area many times. In this case, either stream data item is rewritten each time. Hence, the recorded signal representing the stream data item will not be degraded in strength. By contrast, the two data items recorded, respectively, in two tracks immediately preceding and following the track holding stream data item A, i.e., track data item A-H and track data item A-N, and the two data items recorded, respectively, in two tracks immediately preceding and following the track holding stream data item B, i.e., track data item B-H and track data item B-N, are over-written another time, after the stream data item is written. These data items may more likely be erased than stream data items A and B, if they are not rewritten at all.

Therefore, track data items A-H and B-H that includes the head addresses of the stream data items A and B, respectively, are not written in the disk 10 in the disk drive 1 according to this embodiment. Instead, as shown in FIG. 8, track data items A-H and B-H are stored in the flash memory 22 used as a substituted recording area. Further, track data items A-N and B-N in the tracks next to the end tracks holding stream data items A and B, respectively, are stored in the flash memory 22, too. Thus, the number of times data is over-written in two tracks adjacent to stream data item A is reduced, and so is the number of times data is over-written in two tracks adjacent to stream data item B. This can prevent the data recorded in these tracks from being erased.

The track data items stored thus stored in the flash memory 22 used that is used as a substituted recording area is managed in a stream-data management table shown in FIG. 2. The stream-data management table is stored in the system area provided on the disk 10. The serial numbers of any tracks substituted, the sizes of track data items, the start address of the flash memory 22, and link data items (1 to X) are registered in the stream-data management table.

The link information is attribute information that represents the relation between the substituted tracks, on the one hand, and the blocks of the flash memory 22, on the other. (Thus, the link information identifies the blocks holding track data items and represents the order in which the blocks are arranged.) Hence, if any address is discontinuous to the next one in the flash memory 22, the link information shows which block of the flash memory 22 holds which tack data item. The disk controller 20 refers to a block-use management table showing the blocks used as erase units, in order to save data items in the flash memory 22. Data items are saved in the vacant blocks found in the block-use management table. The flash memory 22 has as many blocks (each capable of holding, e.g., 128 kB) as can hold the largest one-track data (e.g., 600 kB) recorded in the disk 10. Thus, the flash memory 22 can save the substituted track data.

As FIG. 7 shows, non-stream data items P-1 and P-2, which constitute data smaller than one-track data, may be written at random in the same track. These data items P-1 and P-2 may be repeatedly written more times than stream data. Inevitably, the data items recorded in the tracks adjacent to the tracks holding non-stream data items P-1 and P-2 may be erased at high probability. Therefore, non-stream data items P-1 and P-2, which may be written many times, are stored in the flash memory 22, too, in the present embodiment.

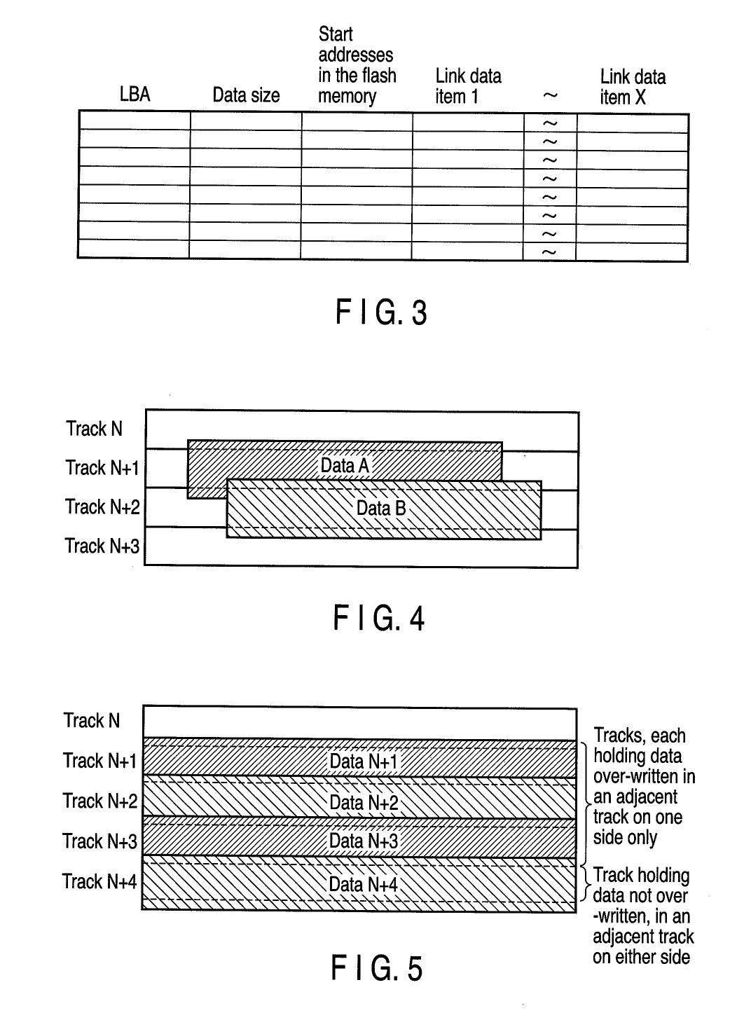

In this case, the non-stream data items P-1 and P-2 are managed by using such a substituted-track management table as shown in FIG. 3. These data items P-1 and P-2 are stored not in units of tracks, but in units of sectors. The logic address (LBA) and size of each data item must be registered in association with an address in the flash memory. Therefore, the substituted logic addresses (LBAs), the sizes of data items, the start addresses in the flash memory 22, and link data items (1 to X) are registered in the substituted-track management table shown in FIG. 3. In the management table shown in FIG. 3, the logic addresses (LBAs) may be replaced by the physical addresses on the disk 10.

(Specific Example of the Data-Writing Method)

FIGS. 9A and 9B, FIGS. 10A and 10B, and FIGS. 11A and 11B are diagrams explaining how new stream data is written, either continuous to, or overlapping, the stream data recorded in the disk 10.

FIG. 9A illustrates stream data item A (i.e., head track data item A-H) already recorded in the disk 10. As pointed out above, head track data item A-H and track data item A-N about a track adjacent to the end track are saved in the flash memory 22, not in the disk 10. Assume that new stream data item (hereinafter called item C) is written in addition to stream data item A already recorded. In this case, head track data item C-H of the stream data item C is saved in the flash memory 22, in addition to the substituted head track data item A-H. Therefore, the data is not written in the head track C-H of the disk 10, which is shown in FIG. 9B. Track data item A-N stored in the flash memory 22 becomes unnecessary. Thus, the track data item C-N about a track adjacent to the end track for stream data item C is saved in place of track data item A-N.

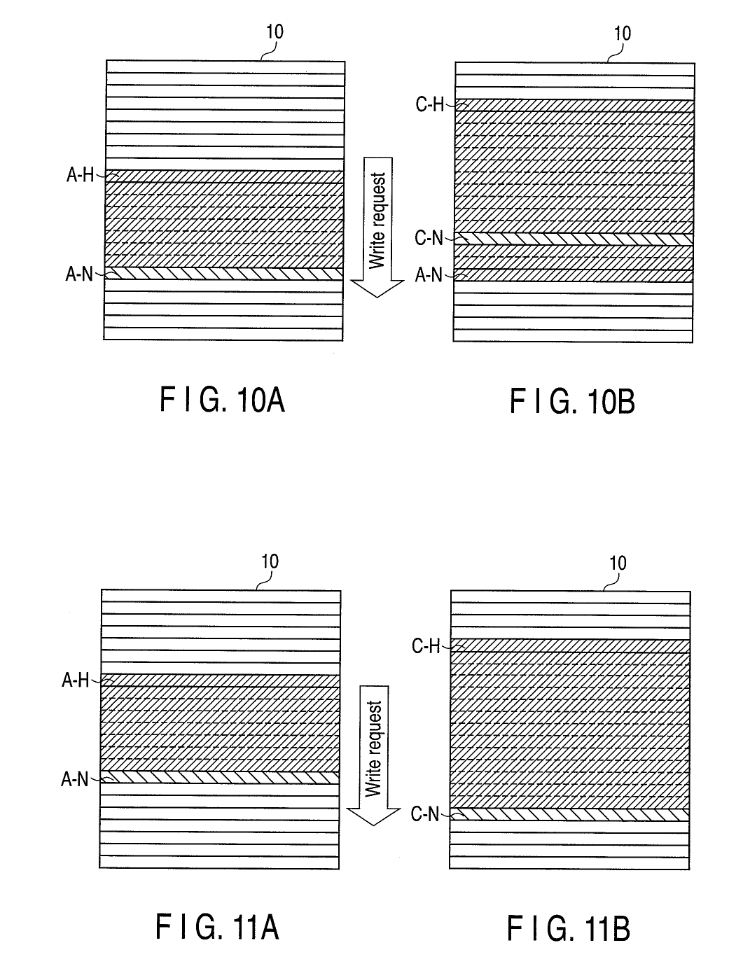

Assume that new stream data item C is written in addition to stream data item A already recorded, as illustrated in FIG. 10A. That is, as shown in FIG. 10B, new stream data item C including head track data item C-H is over-written to the middle of stream data item A. Head track data item C-H is not written in the disk 10, but is stored in the flash memory 22. Track data item A-H stored in the flash memory 22 becomes unnecessary. Track data item A-N remains stored in the flash memory 22, and new track data C-N is saved.

Further assume that data is written over entire stream data item A in the disk 10 as illustrated in FIG. 11A. Then, as shown in FIG. 11B, new stream data C including head track data item C-H is over-written in entire area in which stream data item A is recorded. Head track data item C-H is not written in the disk 10, but is stored in the flash memory 22. Track data items A-H and A-N, both stored in the flash memory 22, become unnecessary. In the flash memory 22, track data item C-N is saved, along with head track data items C-H.

(Sequence of Writing Stream Data Items)

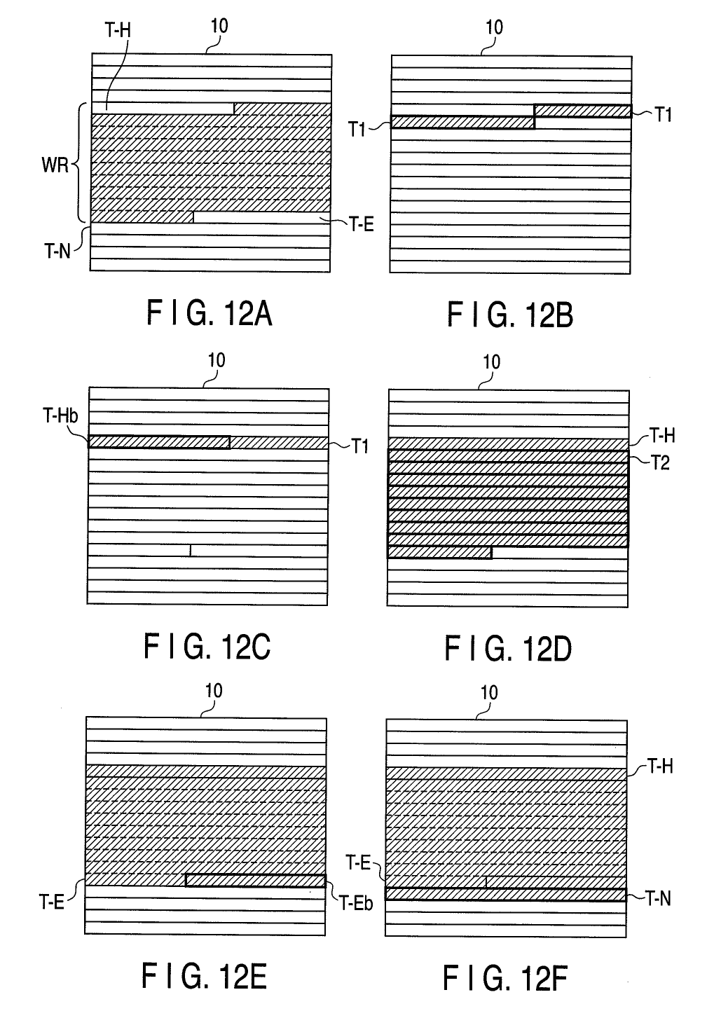

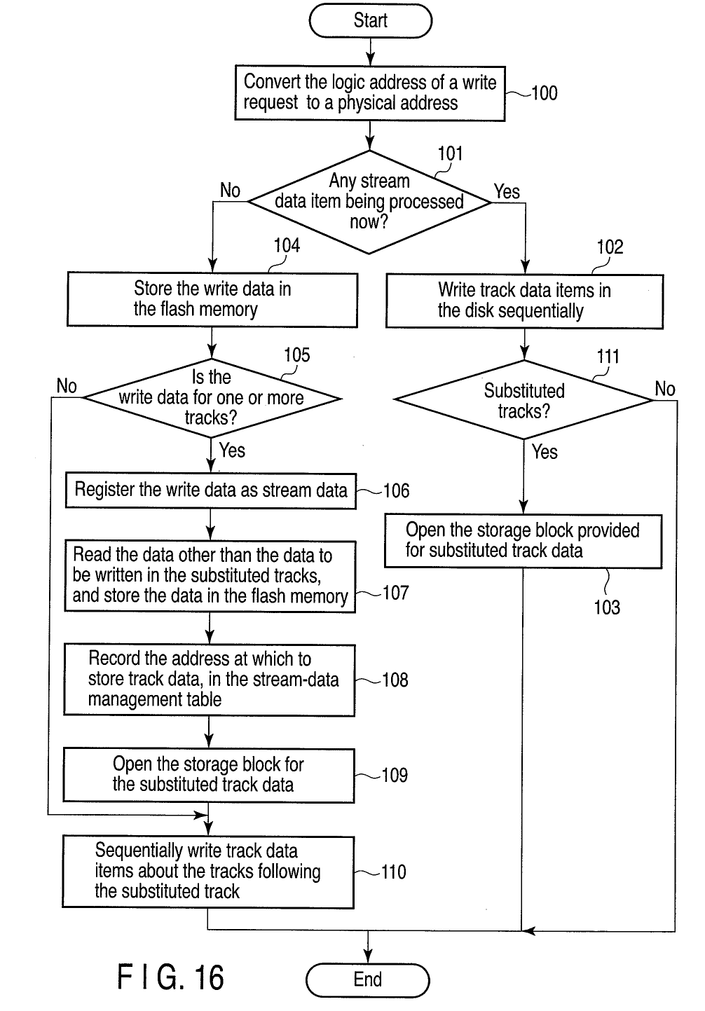

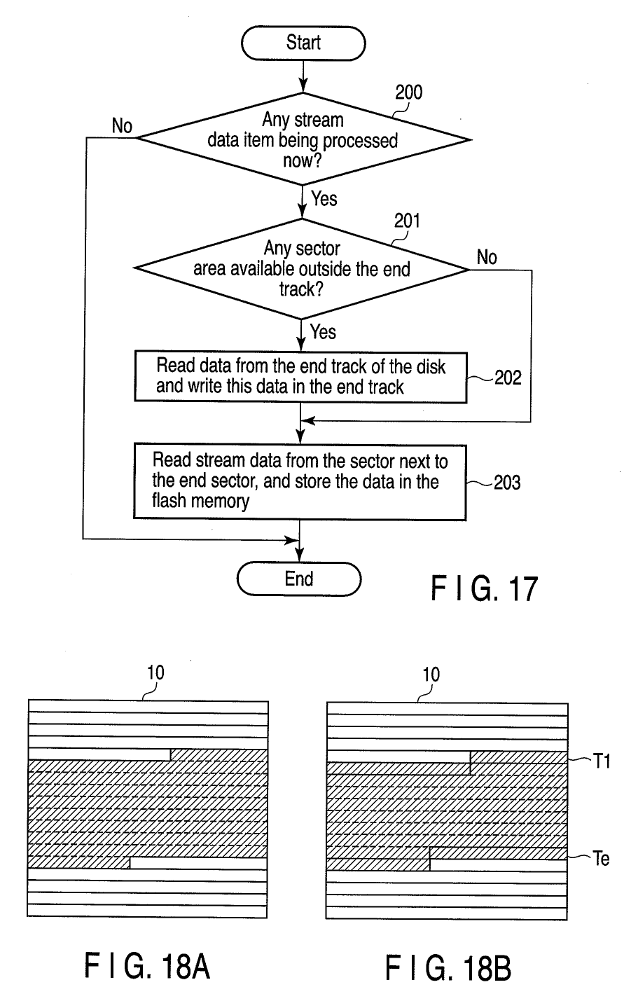

The sequence of writing stream data items will be explained with reference mainly to FIGS. 12A to 12F and the flowcharts of FIGS. 16 and 17.

First, the host system 2 determines a write-requested area (write-access area) WR on the disk 10, in which stream data items should be saved, as is illustrated in FIG. 12A. Note that the write-request area WR extends from a middle sector of a track (more precisely, head track) T-H to a middle sector of a track (more precisely, end track) T-E.

As shown in the flowchart of FIG. 16, the disk drive 1 converts the logic address of a write request transmitted from the host system 2, to a physical address that identifies the write-request area WR provided on the disk 10 (Block 100). To save the stream data from the beginning, the data T1 for the first track is stored in the flash memory 22 as shown in FIG. 12B (Block 104, if NO in Block 101). The CPU 19 and the disk controller 20 jointly perform write operation for the disk 10 and flash memory 22. In the following description of this embodiment, the controls the CPU 19 performs will not be particularly distinguished from the controls the disk 20 performs. In other words, all controls will be regarded as being performed in the disk drive 1.

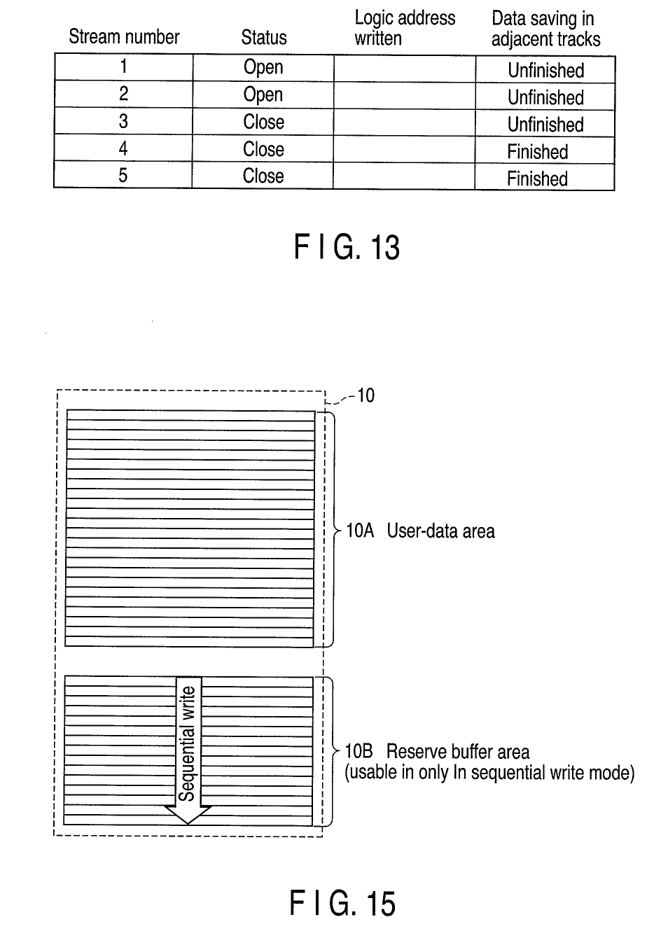

Upon finding that write data coming from the host system 2 represents consecutive addresses for one or more tracks, the disk drive 1 determines that the write data is stream data. In this case (if YES in Block 105), the disk drive 1 registers the write data in the stream-data management table as illustrated in FIG. 13 (Block 106). That is, in order to register the write data anew as stream data, an area for storing the write data is earmarked in the flash memory 22. Data T1 for the first track is then stored in the flash memory 22.

Next, the disk drive 1 reads, from the disk 10, data T-Hb recorded in the head track T-H and being other than the data to be written (i.e., part of the data, other than data T1). Data T-Hb, thus read, is stored in the flash memory 22 (Block 107). At this point, the address, at which data T-Hb should be written in the flash memory 22, is recorded in the stream-data management table shown in FIG. 2 (Block 108).

The data about the track (i.e., head track T-H) may exists in the flash memory 22. In this case, this data is no longer necessary. The storage area (storage block) of the flash memory 22 is therefore free area (Block 109). If the track data is found to be stream data, track data T2 about the second track of the stream data needs not be stored in the flash memory 22. Therefore, track data T2 needs not be stored into the flash memory 22.

The disk drive 1 sequentially writes track data item T2 about the second track next to the head track T-H (i.e., substituted track) and track data items about the tracks following the second track in continuous areas provided on the disk 10 (Block 110). The data about the head track T-H is saved in the flash memory 22 as substituted track data item T1.

Upon lapse of a preset time after the last write request came from the host system 2, the disk drive 1 determines that the stream data has been written completely. Thereafter, the disk drive 1 reads data T-Eb recorded outside the write area provided in the end track T-E of the disk 10 as illustrated in FIG. 12E, and then writes data T-Eb again in the same area outside the write area. Next, the disk drive 1 reads data from the track T-N next to the end track T-E and stores this data in the flash memory 22 as shown in FIG. 12F. Then, the disk drive 1 terminates the process of writing the stream data. (The termination of this process is equivalent to the process of closing status, which will be described later.)

On receiving a write request coming from the host system 2, requesting for the writing of track data item T2 about the second track next to the head track T-H (i.e., substituted track) and track data items about the tracks following the second track, the disk drive 1 sequentially writes these track data items in the consecutive areas provided on the disk 10 as shown in FIG. 12D (Block 102, if YES in Block 101). At this time, the substituted track data stored in the flash memory 22 is no longer necessary if a substituted track exists to be over-written. Therefore, the disk drive 1 opens the storage area (storage block) provided for the substituted track data (Block 103, if YES in Block 111).

As shown in FIG. 13, the stream-data management table stores stream numbers, statuses, written logic addresses (alternatively, written physical addresses), and saving attributes of adjacent tracks, which are allocated to stream data items registered. Of the statuses, “open” is attribute data indicating that the stream data is being written. Upon receiving a write request from the host system 2, the disk drive 1 refers to the written logic addresses, determining which stream data item the write request is concerned with. If the write request is concerned with the stream data item now opened, the disk drive 1 keeps on writing the stream data item. Of the statuses, “close” is attribute data indicating that the stream data has been written.

The disk drive 1 sets the status of each stream data item to “close” in the stream-data management table shown in FIG. 13, when it assumes an idling state if no write requests have come from the host system 2 for a preset time. Alternatively, the disk drive 1 may assign a time stamp to each stream data item, and may set the status of the stream data item to “close” upon lapse of a preset time from the last access made to the stream data item. The disk drive 1 performs such a process as shown in FIG. 12E or 12F on any stream data item set to “close” status. When the track data item is saved, the saving attribute of adjacent tracks is set to “saved.”

FIG. 17 is a flowchart explaining the sequence of setting the status of each stream data item to “close” when the disk drive 1 assumes an idling state.

If any stream data item is open, or being written, and if any free sector area exists in the end track, the disk drive 1 reads data from the end track of the disk 10 and write this data in the end track (Blocks 200 to 202). Then, as shown in FIG. 12F, the disk drive 1 reads data from track T-N next to the end track T-E and stores this data in the flash memory 22 (Block 203).

(Management of the Data Stored in the Flash Memory)

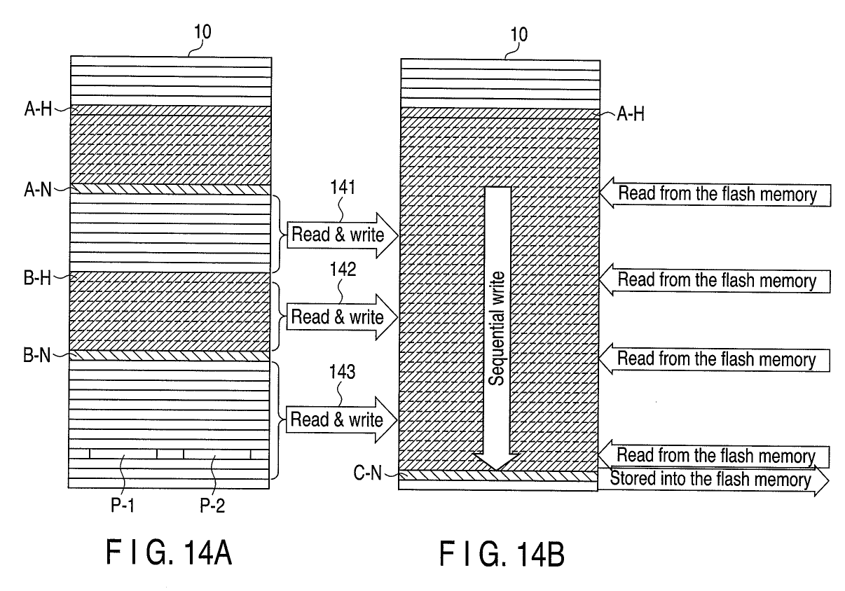

FIG. 14A is a diagram explaining how to write the substituted track data stored in the flash memory, back into the disk 10.

As described above, some track data items are stored as substituted track data in the flash memory 22 in this embodiment, in order to write (record) the stream data items sequentially back into the disk 10. This reduces the number of times data is overwritten in the two tracks adjacent to the track in which the stream data is recorded. If many stream data items that are relatively small in amount are written in the disk 10, however, more and more substituted track data items will be stored in the flash memory 22. Consequently, the vacant storage area available in the flash memory 22 may become insufficient. Inevitably, no more substituted track data items may be written in the flash memory 22.

To write more substituted track data items in the flash memory 22, the disk drive 1 according to this embodiment read substituted track data items from the flash memory 22 and writes them back into the disk 10. Note that these data items should be written back into the disk 10 in sequential write mode. That is, the substituted track data items cannot be written back into the disk 10 in the order they were stored into the flash memory 22.

More specifically, as shown in FIG. 14B, the disk drive 1 performs sequential write in a given area that is continuous to substituted track A-N lying adjacent to a track in which stream data is recorded. At this time, the disk drive 1 reads substituted track data from the flash memory 22 and writes the same in a designated position in the disk 10 and reads other data items from the disk 10 and write them sequentially back into the disk 10 at designated positions therein (Blocks 141 to 143). Further, as shown in FIG. 14B, the disk drive 1 reads data from the track next to the track from which data has been read and stores this data in the flash memory 22.

Because of this process the disk drive 1 performs, the substituted track data now recorded in the sequential-write area need not be stored in the flash memory 22. That storage area of the flash memory 22, which is earmarked for substituted data items, can be opened. This increases the usable storage capacity of the flash memory 22, particularly if the sequential-write area in the disk 10 is large. However, this process imposes a load on the disk drive 1. Hence, it is desired that the disk drive 1 should perform this process, in accordance with the usable storage capacity of the flash memory 22, while no commands are coming from the host system 2.

FIG. 15 is a diagram explaining a process of writing stream data in the disk 10 if the flash memory 22 has no vacant storage areas. This process is not absolutely necessary in this embodiment, nevertheless. The process explained above with reference to FIGS. 14A and 14B may be performed instead, if the flash memory 22 has no vacant storage areas.

The disk driver 1 provides a reserve buffer area 10B on the disk 10, in addition to the ordinary user-data area 10A, as is illustrated in FIG. 15. The buffer area 10B is dedicated to sequential write and consists of tracks continuous in the radial direction of the disk 10. When the flash memory ceases to have any vacant storage areas, the disk drive 1 temporarily stores stream data including the head address in the buffer area 10B (in sequential write mode). When a vacant storage area becomes available in the flash memory 22, the disk drive 1 reads the stream data from the buffer area 10B and sequentially writes the stream data at the proper address in the disk 10. At this point, the disk drive 1 stores a one-track data item including the head address of the stream data in the vacant storage area available in the flash memory 22.

As the process described above proceeds, the stream data can undergo sequential write by utilizing the reserve buffer area 10B even if no vacant storage areas are available in the flash memory 22. When a vacant storage area becomes available in the flash memory 22, the one-track data including the head address of the stream data can be stored in the flash memory 22.

Thus, in the present embodiment, the number of times data is over-written in both tracks adjacent to each track during the sequential writing of data in this track is limited, thereby reducing the track pitch. This will ultimately increase the storage capacity of the disk.

(Another Embodiment)

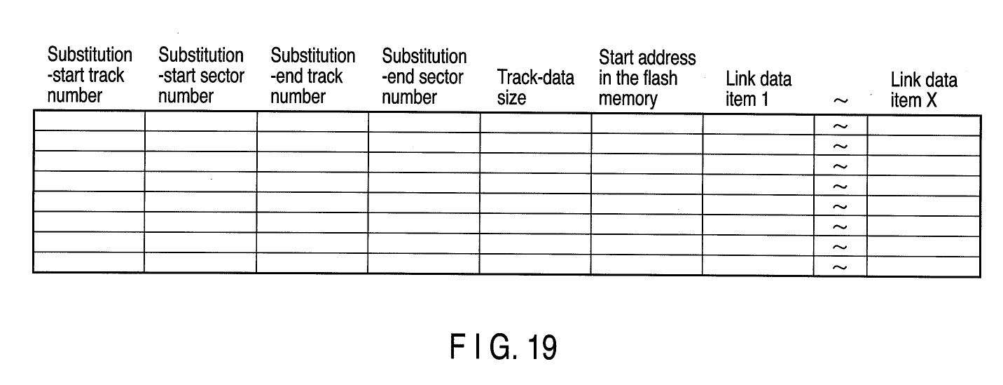

FIGS. 18A and 18B and FIG. 19 are diagrams explaining another embodiment of the present invention. The disk drive 1 according to the other embodiment is identical in configuration to the disk drive 1 shown in FIG. 1 and will not be shown or described.

The disk drive 1 according to the embodiment described above writes, in the flash memory 22, one-track data about a track, which includes the head address of stream data, and another one-track data about the track adjacent to the track, which includes the end address of the stream data. By contrast, the disk drive 1 according to the other embodiment writes, in the flash memory 22, one-track data T1 including the head address of stream data and one-track data Te including the end address of the stream data as shown in FIG. 18B, with respect to the write request to the write-requested area on the disk 10, which is shown in FIG. 18A.

In this data-writing process, the disk drive 1 uses such a substituted-track management table as shown in FIG. 19. Unlike the substituted-track management table shown in FIG. 3, this substituted-track management table shows substitution-start track numbers, substitution-start sector numbers, substitution-end track numbers, and substitution-end sector numbers. The other embodiment is designed on the assumption that the logic address of the smallest serial number in each track is aligned with that of the smallest serial number in any other track, in the circumferential direction of the disk 10. Hence, the data recorded in each track would be over-written in both adjacent tracks on the disk 10, which have not substituted yet. Hence, the other embodiment cannot be used if the logic address of the smallest serial number in each track is not aligned, in the circumferential direction, with that of the smallest serial number in any other track.

To summarize the above, the number of times the stream data is over-written, while being sequentially written in any track on the disk 10, in two adjacent tracks on both sides of the track can be limited to, for example, once. This can reduce the track pitch, ultimately increasing the storage capacity of the disk 10. Moreover, the one-track head data at the head address of the stream data is stored in the flash memory 22. The flash memory 22 can therefore access the head data in order to playback, for example, a TV program from the beginning, before the head seek (read access) is completed on the disk 10. This can shorten the response time in the playback mode.

Furthermore, non-stream data items (P-1 and P-2), such as attribute data items, which are, in amount, equal to or smaller than one-track data, are stored in the flash memory 22. This helps to reduce greatly the number of times the disk 10 is accessed.

The advantages of each embodiment will be explained more specifically.

Assume that the disk drive 1 has a disk 10 having a storage capacity of 320 GB. Then, if the number of times the data is over-written on two adjacent tracks on both sides of each track is limited, the actual storage capacity of the disk 10 can be increased by about 16%. That is, the storage capacity of the disk 10 can increase to 372 GB. If one stream data item represents a five-minute program (3 MB/s×300 s=900 MB), the disk drive 1 that has the disk 10 having the increased storage capacity of 371 GB can store 412 stream data items at most. Since each track has a storage capacity of about 600 KB at most, the flash memory 22 needs to have storage capacity of 494 MB in order to hold two-track data for each stream data item.

If the flash memory 22 has a storage capacity of about 1 GB, like most flash memories developed in recent years, one half of its storage capacity can be allocated to the substituted track data, while the other half is allocated to the non-stream data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk having a plurality of concentric tracks used as data-recording areas;
a head configured to read data from the disk, and write data in the disk;
a flash memory configured to store data; and
a controller configured to control the reading of data from the disk, the writing of data in the disk, and the writing of data in the flash memory,
wherein the controller is configured to determine whether requested data transmitted from a host system for recording in the disk is continuous data to be written in at least two adjacent tracks of the disk specified by consecutive addresses, configured to store the first one-track data item comprising the head address of the requested data in the flash memory when the requested data is the continuous data, and configured to sequentially write the second to last one-track data items in the disk.

2. The disk drive of claim 1, wherein the control module is configured to store the data for recording in the tracks adjacent to the track comprising the end address of the continuous data in the flash memory.

3. The disk drive of claim 1, wherein the control module is configured to write sequentially the second to last one-track data items in the flash memory after storing the first data item in the flash memory, the second one-track data item being recorded in tracks adjacent to the track comprising the head address of the requested data.

4. The disk drive of claim 1, wherein the controller is configured to read the remaining portion of the requested data from the last track first and configured to write the remaining portion of the requested data in the last track of the disk when the requested data terminates at a middle of the last track of the disk while the data comprising the end address is being written in the last track.

5. The disk drive of claim 1, wherein the controller module is configured to determine that the continuous data has been written completely if no further data to the continuous data is received from the host system after a preset time elapses from the time when the requested continuous data was written in the disk.

6. The disk driver of claim 1, wherein the controller is configured to determine that the continuous data has been written completely if no further data to the continuous data is received from the host system after a preset time elapses from the time when the requested continuous data was written in the disk, and the controller is configured to store the data recording in the track adjacent to the last track comprising the end address of the continuous data.

7. The disk driver of claim 1, wherein the controller is configured to read the data stored in the flash memory, configured to write the data back in the disk at a designated position in the area where the continuous data is recorded, configured to read the continuous data from the disk at the designated position, configured to continuously write the data again in the disk, configured to read data from the track next to the track from which data has been read for the last time, and configured to store the data in the flash memory.

8. The disk drive of claim 1, wherein the controller is configured to secure a reserve buffer for holding the continuous data on the disk, configured to store the continuous data temporarily in the reserve buffer when no areas are available in the flash memory, configured to read the continuous data from the reserve buffer area and to write the continuous data at an original address position on the disk when areas are available in the flash memory, and configured to stores the first one-track data comprising the head address of the continuous data in the areas available in the flash memory.

9. The disk drive of claim 1, wherein the controller is configured to store the one-track data comprising the end address of the requested data together with the first one-track comprising the head address of the requested data in the flash memory.

10. A method of writing data in a disk drive having a disk, a head and a flash memory for storing data, the method comprising:
determining whether requested data transmitted from a host system for recording in the disk is continuous data to be written in at least two adjacent tracks of the disk specified by consecutive addresses;
storing the first one-track data item comprising the head address of the requested data in the flash memory when the requested data is the continuous data; and
sequentially writing the second to last one-track data items in the disk.

11. The method of claim 10, further comprising storing the data for recording in the tracks adjacent to the track comprising the end address of the continuous data in the flash memory.
